(19) United States
(12) Patent Application Publication
(10) Pub. No.: US 2024/0428170 A1
(43) Pub. Date: Dec. 26, 2024

(54) CONTEXT-AWARE AUTOMATION ARCHITECTURE

(71) Applicant: International Business Machines Corporation, Armonk, NY (US)

(72) Inventors: Sarbajit K. Rakshit, Kolkata (IN); Naeem Altaf, Round Rock, TX (US)

(21) Appl. No.: 18/341,150

(22) Filed: Jun. 26, 2023

(51) Int. Cl. G06Q 10/0639

(52) U.S. Cl. CPC G06Q 10/06393

(57) ABSTRACT

A context-aware automation system is presented including performing a business process within a geographical boundary, capturing data from a plurality of sensors and cameras positioned in and around the geographical boundary, the data pertaining to different stages of the business process, detecting contextual changes within the geographical boundary, identifying data insufficiency within the different stages of the business process, requesting a satellite service provider to initiate communication with one or more satellites to obtain complementary business process data based on software-defined satellite rules, transmitting, by the one or more satellites, the complementary business process data based on the software-defined satellite rules to a cloud service provider communicating with one or more user terminals to evaluate a quality of key performance indicators (KPIs) extracted from the complementary business process data, and employing one or more of the KPIs to resolve the data insufficiency within the different stages of the business process.

### BACKGROUND

The present disclosure relates generally to business processes, and more specifically, to applying a context-aware automation architecture to a business process.

A business process is a collection of linked tasks that find their end in the delivery of a service or product to a client. A business process has also been defined as a set of activities and tasks that, once completed, will accomplish an organizational goal. The process must involve clearly defined inputs and a single output. These inputs are made up of all of the factors that contribute (either directly or indirectly) to the added value of a service or product. These factors can be categorized into management processes, operational processes, and supporting business processes. Management processes govern the operation of a particular organization's system of operation. Operational processes constitute the core business. Supporting processes, such as human resources and accounting, are put in place to support the core business processes.

### SUMMARY

In accordance with an embodiment, a method for employing a context-aware automation system is provided. The method includes performing a business process within a geographical boundary, capturing data from a plurality of sensors and cameras positioned in and around the geographical boundary, the data pertaining to different stages of the business process, detecting contextual changes within the geographical boundary, identifying data insufficiency within the different stages of the business process, requesting a satellite service provider to initiate communication with one or more satellites to obtain complementary business process data based on software-defined satellite rules, transmitting, by the one or more satellites, the complementary business process data based on the software-defined satellite rules to a cloud service provider communicating with one or more user terminals to evaluate a quality of key performance indicators (KPIs) extracted from the complementary business process data, and employing one or more of the KPIs to resolve the data insufficiency within the different stages of the business process. Additional aspects of the present disclosure are directed to systems and computer program products configured to perform the methods described above.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The present disclosure will provide details in the following description of preferred embodiments with reference to the following figures wherein:

FIG. 1 is a block/flow diagram of an exemplary context-aware automation architecture evaluating data insufficiency to monitor different stages of a business process, in accordance with an embodiment of the present disclosure;

FIG. 2 is a block/flow diagram of an exemplary context-aware automation architecture evaluating data insufficiency in an agricultural business process, in accordance with an embodiment of the present disclosure;

FIG. 3 is a block/flow diagram of a practical application illustrating stages of a farm production process, in accordance with an embodiment of the present disclosure;

FIG. 4 is a block/flow diagram of a practical application illustrating stages of a food supply chain flow, in accordance with an embodiment of the present disclosure;

FIG. 5 is a block/flow diagram of a practical application illustrating the application of the context-aware automation architecture to a food supply chain flow, in accordance with an embodiment of the present disclosure;

FIG. 6 is a block diagram of an exemplary computer system to apply the context-aware automation architecture of FIG. 1, in accordance with an embodiment of the present disclosure;

FIG. 7 illustrates practical applications for employing the context-aware automation architecture via an artificial intelligence (AI) accelerator chip, in accordance with an embodiment of the present disclosure; and

FIG. 8 is a block/flow diagram of exemplary Internet-of-Things (IoT) sensors used to collect data/information related to the context-aware automation architecture operations, in accordance with an embodiment of the present disclosure.

Throughout the drawings, same or similar reference numerals represent the same or similar elements.

### DETAILED DESCRIPTION

Embodiments in accordance with the present disclosure provide methods and systems for evaluating a business process and identifying what data and information is missing or not considered by the business process, and determining what data or information can be captured by one or more satellites to compensate for such missing (or insufficient) data or information. The exemplary context-aware automation system requests satellite service providers to capture such missing (or insufficient) data or information.

A business process has multiple stages and also has different execution sequences. Each and every business process has its own lifecycle, and each stage is monitored precisely. Sensor and image feeds are used for monitoring different stages of the business process. For any change in context, the sequence of activities, different sets of data and information are needed. In general, sensors are employed around the fixed activity locations, and may not always be aligned with the change in context, and at the same time, the sensors might get damaged or malfunction. Thus, there can be a data insufficiency in monitoring or controlling different stages of a business process.

The monitoring of different stages of a business process can be, input and output at different stages of the business process, various defined process quality matrices, geographic boundary coverage, duration of execution of different stages of the business process, etc. Then appropriate types of data and information need to be captured, for any contextual scenario changes, such as changes in weather, changing in customer defined monitoring criterial, installing new machines, new way of performing the activity, etc. Thus, if there is data insufficiency, then monitoring may not be proper, and thus data insufficiency at different stages needs to be found, and software defined satellite requirements need to be dynamically generated.

The exemplary embodiments of the present disclosure alleviate such issues by evaluating a business process and identifying what data and information is missing or not considered by the business process, and determining what data or information can be captured by one or more satellites to compensate for such missing data or information. The exemplary context-aware automation system requests satellite service providers to communicate with satellites to capture such missing (insufficient) data or information.

It is to be understood that the present disclosure will be described in terms of a given illustrative architecture; however, other architectures, structures, substrate materials and process features and steps/blocks can be varied within the scope of the present disclosure. It should be noted that certain features cannot be shown in all figures for the sake of clarity. This is not intended to be interpreted as a limitation of any particular embodiment, or illustration, or scope of the claims.

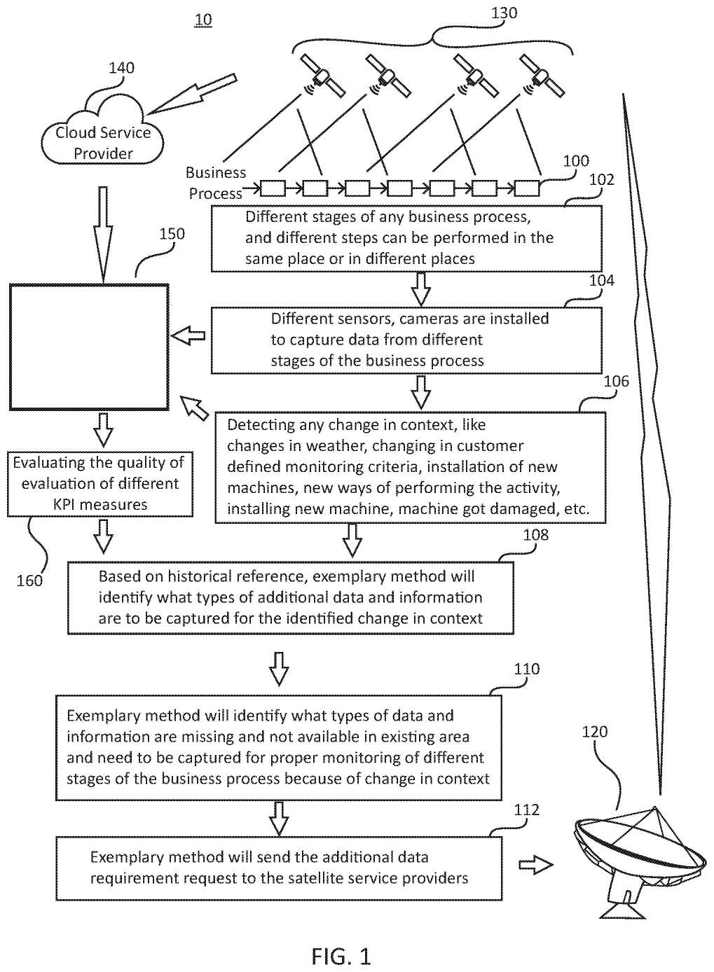

FIG. 1 is a block/flow diagram of an exemplary context-aware automation architecture evaluating data insufficiency to monitor different stages of a business process, in accordance with an embodiment of the present disclosure.

FIG. 1 illustrates how the exemplary embodiments evaluate data insufficiency to measure or monitor or control different stages of a business process 100 to identify what types of data and information are missing or not available, and accordingly, request satellite service providers to communicate with a plurality of satellites to provide for the missing or insufficient data.

The context-aware automation architecture 10 is applied to the business process 100.

At block 102, different stages of the business process 100 can be performed in the same place or in different places (geographic location or area or environment).

At block 104, different sensors and cameras are installed to capture data from different stages of the business process 100.

At block 106, detection in any change in context is performed. For example, changes in weather, changes in customer defined monitoring criteria, installation of new machines, new ways of performing one or more activities, damaged machines, camera malfunctions, sensor malfunctions, other equipment malfunctions, etc.

At block 108, based on historical reference, the exemplary methods identify what types of additional data and information are to be captured for the identified contextual change.

At block 110, the exemplary methods identify what types of data and information are missing and/or not available (or merely insufficient) in existing areas or environments and need to be captured for proper monitoring of different stages of the business process 100 because of the contextual change. Contextual changes can refer to at least changes in weather, changes in customer defined monitoring criteria, installing new machines, new ways of performing the activity, damaged machines, sensor malfunctions, etc.

At block 112, the exemplary methods send the additional data requirement request to the satellite service providers 120.

The satellite service providers 120 transmit the information to a plurality of satellites 130. The plurality of satellites 130 can share such data with a cloud service provider 140. The cloud service provider 140 sends all the data to one or more user terminals 150 which display the key performance indicators (KPIs) at different stages of the business process 100. The quality of different KPI measures are evaluated at block 160. The quality of the KPI measures can be different at different stages of the business process 100.

The business process 100 is a set of related, structured activities and steps performed by individuals or equipment within an organization to achieve the organization's basic objectives, like profit maximization and customer satisfaction. Business processes can be repeated at all organizational levels and may or may not be visible to customers. Stated differently, a business process 100 is an activity or set of activities that accomplish a specific organizational goal. Business processes should have purposeful goals, be as specific as possible and produce consistent outcomes. To measure the success of the business process 100, organizations track the completion of different steps within the process, that is, benchmarks or evaluate the quality of the process endpoint.

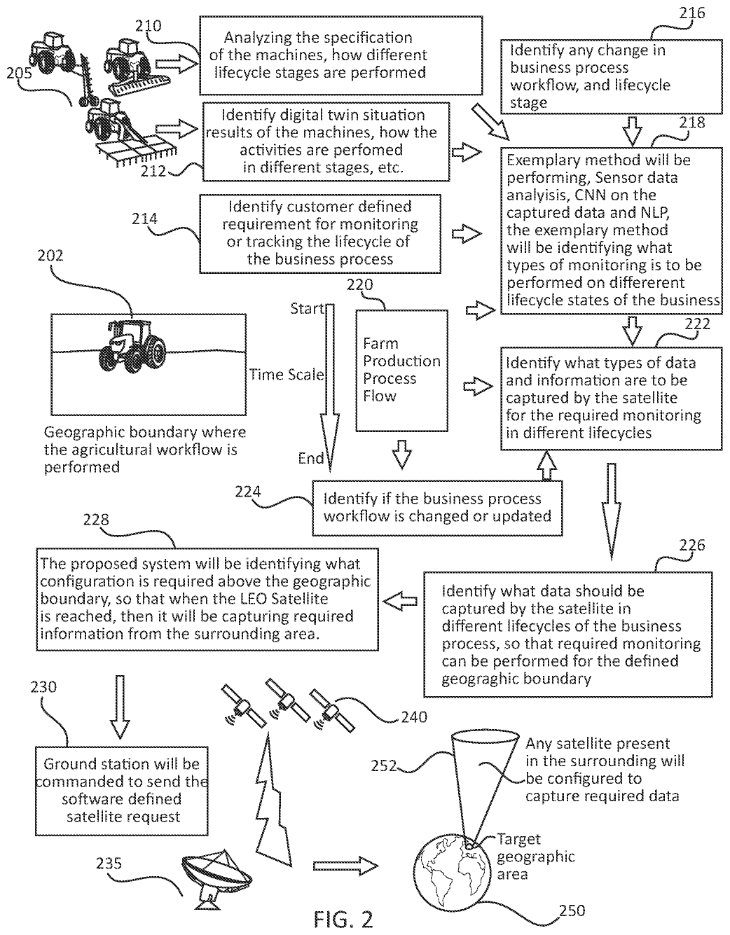

The business process 100 can be applied to any business process by one skilled in the art. For example, the business process 100 can apply to an agricultural environment, as described in detail below with reference to FIG. 2.

Other business processes 100 can include, and are not limited to, a human resource process, a project management process, a social media management process, a customer service process, a marketing process, a product development process, a delivery management system process, an onboarding process, a sales process, a budgeting process, a procurement process, a content promotion process, and an asset management process.

Regarding a human resource process, establishing business processes for hiring new employees can help companies attract and retain qualified professionals. Following a defined set of protocols during the hiring process can help companies hire candidates who can make a difference to their bottom line. Automated hiring tools can speed up the hiring process and save a lot of time HR professionals would spend on screening candidates. These hiring tools can search for keywords in each application that help shortlist suitable candidates for a job role. Automating the human resources processes can ensure faster and cost-efficient hiring. The context-aware automation architecture 10 can be applied to the human resource process.

Regarding a project management process, many companies use project management systems to streamline the project workflow and keep track of the project's timeline. Companies can opt for a proprietary process or companies may use project management software. Most of the project management software can automate the workflow. Most of these automation tools provide a dashboard that displays the activities and tasks of every project member. From initiation and project planning to execution, monitoring and completion, project management software can streamline the project workflow. This can help a complete business project effectively and efficiently. The context-aware automation architecture 10 can be applied to the project management process.

Regarding a social media management process, having a dedicated business account on social media platforms is important and beneficial for growing a business. While operating social media accounts on different platforms is challenging, it is essential for companies to frequently post new updates to grow consumer awareness. Using various social media management software, companies can schedule posts and keep track of the important metrics. Bringing automation can streamline social media presence and ensure companies can grow a loyal base of followers. The context-aware automation architecture 10 can be applied to the social media management process.

Regarding a marketing process, such process includes designing, developing and launching a new product to market. As a result, companies use marketing tools to streamline their processes. By automating a marketing process, companies can align their goals and efforts. Enabling a business process in the marketing department can help in generating more leads and increasing sales. As automation enables a company to increase its conversion rate, it helps manage leads more efficiently. The context-aware automation architecture 10 can be applied to the marketing process.

Regarding a product development process, companies often develop products and this is a business process in itself. Having a business process, especially for product development, can help a company deliver high-quality intangible, tangible and service-based products. The process of product development includes generating an idea, screening and selecting the idea, developing the concept, developing the product, conducting marketing research and finally launching the final product. The context-aware automation architecture 10 can be applied to the product development process.

In summary, with regards to FIG. 1, based on detection of data insufficiency to monitor different stages of a business process, the exemplary methods request satellite service providers to capture needed data (supplemental or auxiliary or complementary) for different stages of the business process, so that data insufficiency can be compensated or supplemented by the satellite data. Based on any change in the context in any stage of the business process, the exemplary methods evaluate what additional data and information are needed and not available within the existing system, and accordingly request satellite service providers for the additional data. To ensure required quality of monitoring, analysis data and information from different stages of the business process, the exemplary methods identify what additional data are to be provided by the satellite so that quality of KPIs is maintained. The additional data can be referred to as auxiliary data or compensatory data or supplemental data or complementary data that fills in the gaps of missing data or insufficient data within the business process 100.

In one embodiment, if a business process is upgraded with different machines, then the exemplary methods consider digital twin simulation of the current upgrades, and accordingly identify what data should be captured by the satellites for the new scenario. Based on changes in geographic boundary of different stages of the business process, the satellites align with the changes in the geographic boundary. Based on customer specified parameters and customized monitoring needs, the exemplary methods identify what additional data and information are to be captured by the plurality of satellites.

FIG. 2 is a block/flow diagram of an exemplary context-aware automation architecture evaluating data insufficiency in an agricultural business process, in accordance with an embodiment of the present disclosure.

FIG. 2 illustrates an exemplary agricultural business process where different life cycles of the agricultural activity need different types of information to be collected and processed. In this case, the customer can define what parameters are to be monitored, the different types of machines to be used, and what activities are being performed by the different machines and in what manner. Thus, the same activity can be performed in different manners so that different sets of data can be captured by the satellites. Moreover, data related to different types of life cycles for different types of crops can be captured. As a result, different sets of data can be collected or captured at different time intervals or at different life cycle stages. The exemplary embodiments can also create or generate rules for the software defined satellites.

Block 202 illustrates the geographic boundary where the agricultural workflow is performed.

Various agricultural machines 205 are used in different life cycle stages of the agricultural process or workflow.

At block 210, the specification of the machines 205 is analyzed and it is determined how different life cycle stages are performed.

At block 212, digital twin situation results of the machines 205 are identified and how the activities are performed at different stages is determined. A digital twin is a digital representation of an intended or actual real-world physical product, system, or process that serves as the effectively indistinguishable digital counterpart of it for practical purposes. Stated differently, a digital twin is a virtual model designed to accurately reflect a physical object. The object being studied is outfitted with various sensors related to vital areas of functionality. These sensors produce data related to different aspects of the physical object's performance, such as energy output, temperature, weather conditions and more. This data is then relayed to a processing system and applied to the digital copy. Once informed with such data, the virtual model can be used to run simulations, study performance issues and generate possible improvements, all with the goal of generating valuable insights, which can then be applied back to the original physical object.

Although simulations and digital twins both utilize digital models to replicate a system's various processes, a digital twin is a virtual environment, which makes it considerably richer for study. The difference between digital twin and simulation is largely a matter of scale. While a simulation usually studies one particular process, a digital twin can itself run any number of useful simulations in order to study multiple processes within, e.g., the agricultural environment.

At block 214, customer defined requirements are identified from monitoring or tracking the lifecycle of the business process 100.

At block 216, any changes in the business process workflow and the life cycle stages are identified.

At block 220, the farm production process flow is identified.

Block 218 receives the inputs from blocks 210, 212, 214, 216, and 220.

At block 218, the exemplary methods perform sensor data analysis, apply a convolutional neural network (CNN) to the captured data and can further apply natural language processing (NLP) techniques. The exemplary method further identifies what types of monitoring is performed on different life cycle states of the business process 100.

At block 222, the architecture 10 identifies what types of data and information are to be captured by the satellite for the monitoring in different life cycles.

At block 224, the architecture 10 identifies if the business process 100 has changed or has been updated. In other words, a workflow of the business process is continuously monitored to determine potential changes or updates to the workflow to render adjustments to the software-defined satellite rules. Software-defined satellite rules can be various rules, e.g., predefined by a user and provided to the satellites beforehand or in real-time, such that satellites can make decisions on what specific type of data (complementary business process data) to send back to complement the existing data (that includes gaps or missing information or errors). Software-defined satellite rules can be directly related to various types of contextual changes.

At block 226, the architecture 10 identifies what data should be captured by the satellite in different lifecycles of the business process 100 so that monitoring can be performed for the defined geographic boundary 202.

At block 228, the exemplary system identifies what configuration is needed above the geographic boundary 202, so that when the satellite is reached, then the satellite captures the necessary information from the surrounding area or environment.

One example of a satellite can be a low earth orbit (LEO) satellite. A LEO orbit is an orbit around earth with a period of 128 minutes or less and an eccentricity of less than 0.25. Most of the artificial objects in outer space are in LEO, with an altitude never more than about ⅓ of the radius of Earth. LEO is an orbit that is relatively close to Earth's surface. It is normally at an altitude of less than 1000 km but could be as low as 160 km above Earth, which is low compared to other orbits, but still very far above Earth's surface. By comparison, most commercial planes do not fly at altitudes much greater than approximately 14 km, so even the lowest LEO is more than ten times higher than that.

Unlike satellites in geostationary orbit (GEO) that must always orbit along Earth's equator, LEO satellites do not always have to follow a particular path around Earth in the same way, that is, their plane can be tilted. This means there are more available routes for satellites in LEO, which is one of the reasons why LEO is used as the orbit.

LEO requires the lowest amount of energy for satellite placement. LEO provides high bandwidth and low communication latency. Satellites and space stations in LEO are more accessible for crew and servicing. Since LEO needs less energy to place a satellite, a satellite there thus needs less powerful amplifiers for successful transmission.

Communications satellites in LEO often work as part of a large combination or constellation of multiple satellites to give constant coverage. In order to increase coverage, sometimes constellations like this, consisting of several of the same or similar satellites, are launched together to create a “net” around Earth. This lets them cover large areas of Earth simultaneously by working together.

At block 230, the ground station is commanded to send the software defined satellite request to a satellite service provider 235, which communicates with a plurality of satellites 240.

Therefore, any satellite present in any surrounding area 252 of a target geographic area on Earth 250, is configured to capture the necessary data. In one embodiment, the one or more satellites 240 are selected based on their proximity to the geographical boundary 202.

Therefore, in summary, in accordance with FIGS. 1 and 2, based on the captured data, the exemplary methods identify the geographic boundary where the business process 100 is performed. Based on the defined geo-coordinate range, the exemplary methods identify the geographic boundary where different stages of the business process 100 are executed. The exemplary methods capture the geo-coordinate boundary where different stages of the business process 100 are executed and also identify the orbital line of sight from different satellites. The exemplary methods further identify what types of data gathering sensors and cameras are installed in the environment, and what types of data and information are generated by those systems. The gathered sensor data and image data are processed by one or more remote servers and evaluate different stages of the business process workflow. Based on image and sensor feed analysis, the exemplary methods calculate different KPIs of different stages of the business process 100. The exemplary methods have quality specification criteria and a monitoring system of different KPIs, and based on the results of the KPIs, the exemplary methods monitor various activities at different stages of the business process 100.

The exemplary methods identify any change in the contextual scenario (contextual changes) in the activity area and also in different stages of the activity. The contextual scenario or contextual changes can be, changes in weather, changes in customer defined monitoring criteria, installing new machines, new ways of performing the activity, damaged machines, sensor malfunctions, etc.

Based on IoT and image analysis, the contextual scenario can be detected at different stages of the business process, and based on historical data, the exemplary methods identify what types of data and information are to be captured for the analysis. Based on the change in the contextual scenario, the exemplary methods perform data sufficiency evaluation, where data sufficiency means checking and testing a given set of information to determine if it is enough to answer a given scenario. While performing data sufficiency evaluation for any detected context, the exemplary methods identify which data is not available, such as a machine is not able to check the ground condition after a rain event, it is having some difficulty, or a sensor got damaged, etc., and detection of ground moisture, soil condition is needed for the machine to perform properly. Based on different identified contextual scenarios (contextual changes), the exemplary methods use historical references to identify what types of data and information are needed for proper monitoring and tracking of different stages of the business process.

The exemplary methods further identify if there is any change in the execution stages, and also identify changes in the business process. Based on the change in the context, the exemplary methods identify if necessary data and information can be gathered from the environment which can be used for measuring the KPI. Based on the available data and information, the exemplary methods calculate the KPIs and also validate if new sets of KPIs can also be evaluated based on the existing data. Based on historical references, the exemplary methods identify what types of data and information are missing and which are needed for evaluating the KPIs from the activity area at different stages of the business process. Once the data insufficiency is identified, the exemplary methods send the request to the satellite service providers. This data can be referred to as complementary business process data because such data complements the existing data by filling in the gaps of the missing data.

The exemplary methods identify what types of data and information are captured by the satellites from different stages of the business process and the business process stage can be identified based on schedule or events. The satellite service providers provide notifications with the necessary data capture from the geo-fencing area. Once the request is sent to the satellite service providers, then the exemplary methods create or generate software defined rules for the satellites. Once the software defined rules for the satellites are created or generated, then when any satellite is within the line of sight of the geo-fencing area, such satellites capture the needed information (supplemental or auxiliary or compensatory or complementary business process data) and send such information (complementary business process data) back to the business process.

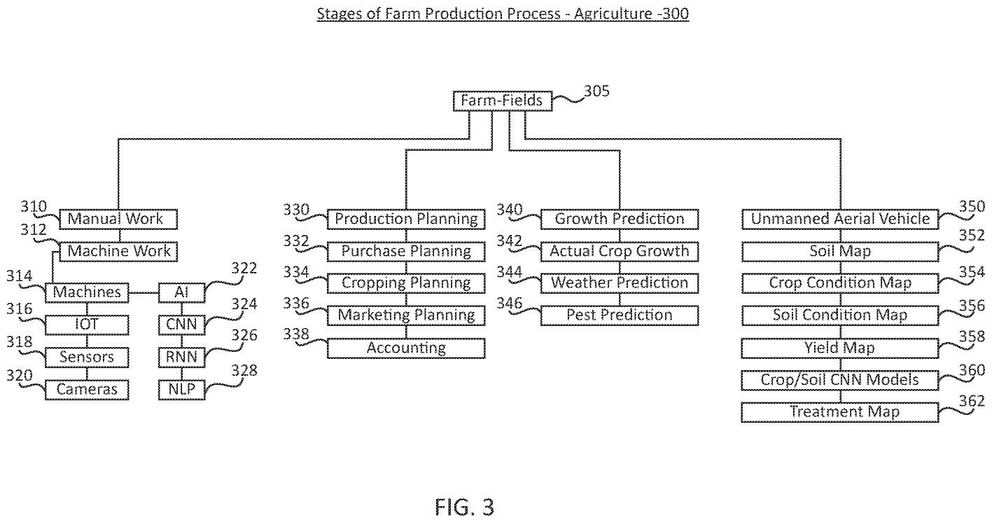

FIG. 3 is a block/flow diagram of a practical application illustrating stages of a farm production process, in accordance with an embodiment of the present disclosure.

The stages of a farm production process 300 can, in one instance, be envisioned as follows. The farms or fields 305 need manual labor 310 and/or machine work 312. The machine work 312 can be performed by machines 314, including Internet of Things (IoT) 316, sensors 318, and cameras 320. The machines 314 can employ artificial intelligence (AI) 322, which in turn uses, for example, convolutional neural networks (CNN) 324, recurrent neural networks 326, and/or natural language processing (NLP) 328.

Artificial Intelligence (AI) refers to the process of machines receiving, analyzing, and combining information in a way that allows them to perform tasks usually performed by humans, such as visual and auditory recognition, decision making, language processing, and many more. AI is a method of making a computer, a computer-controlled robot, or a software think intelligently like the human mind. AI is accomplished by studying the patterns of the human brain and by analyzing the cognitive process.

Stated differently, AI aims to create intelligent machines that can learn from experience and perform tasks that usually need human-like cognitive abilities. AI systems use a combination of algorithms, machine learning techniques, and data analytics to simulate human intelligence. The goal of AI is to create machines that can perceive their environment, reason about it, and take action to achieve specific goals.

AI works by using algorithms and statistical models to analyze large amounts of data, recognize patterns, and make predictions or decisions. The process involves several steps, including data collection, data preprocessing, model selection, training, and validation. During the training phase, the AI system learns from examples by adjusting the weights of its neural network based on the input and output data. Once the system is trained, it can use its knowledge to perform various tasks, such as image recognition, language translation, or speech synthesis.

Machine learning is a subfield of artificial intelligence that focuses on the development of algorithms and models that can learn from data and make predictions or decisions. Machine learning techniques can be broadly classified into three categories, that is, supervised learning, unsupervised learning, and reinforcement learning. In supervised learning, the algorithm is trained on labeled data, where the input and output pairs are known. Unsupervised learning, on the other hand, involves training the algorithm on unlabeled data, where the goal is to identify patterns and relationships in the data. Reinforcement learning is a type of machine learning where the algorithm learns by interacting with an environment and receives feedback in the form of rewards or penalties.

Deep learning is a subset of machine learning that uses artificial neural networks to model and solve complex problems. Deep learning algorithms are composed of multiple layers of interconnected nodes that can process input data and extract features automatically. The neural network is trained using large amounts of data, where the weights of the connections between the nodes are adjusted to minimize the error between the predicted and actual outputs. Deep learning has been used in a wide range of applications, such as image and speech recognition, natural language processing, and autonomous vehicles.

A neural network is a type of artificial intelligence model inspired by the structure and function of the human brain. It consists of layers of interconnected nodes, or neurons, that can process input data and produce output signals. Each neuron receives input signals from other neurons, processes them using an activation function, and sends the output to other neurons in the next layer. Neural networks are trained using supervised learning techniques, where the weights of the connections between the neurons are adjusted to minimize the error between the predicted and actual outputs. Neural networks are a powerful tool in artificial intelligence and have been used in many applications, including image and speech recognition, natural language processing, and autonomous systems.

A Convolutional Neural Network (ConvNet/CNN) is a deep learning algorithm that can take in an input image, assign importance (learnable weights and biases) to various aspects/objects in the image, and be able to differentiate one from the other. The pre-processing required in a ConvNet is much lower as compared to other classification algorithms.

Referring back to FIG. 3, the farm production process can further need production planning 330, purchase planning 332, crop planning 334, marketing planning 336, and accounting 338. The farm production process can also use growth prediction 340, actual crop growth 342, weather prediction 344, and pest prediction 346. The farm production process can also use unmanned aerial vehicles 350, soil maps 352, crop condition maps 354, soil condition maps 356, yield maps 358, crop or soil CNN models 360, and treatment maps 362.

The context-aware automation architecture 10 can be applied to the farm production process of FIG. 3.

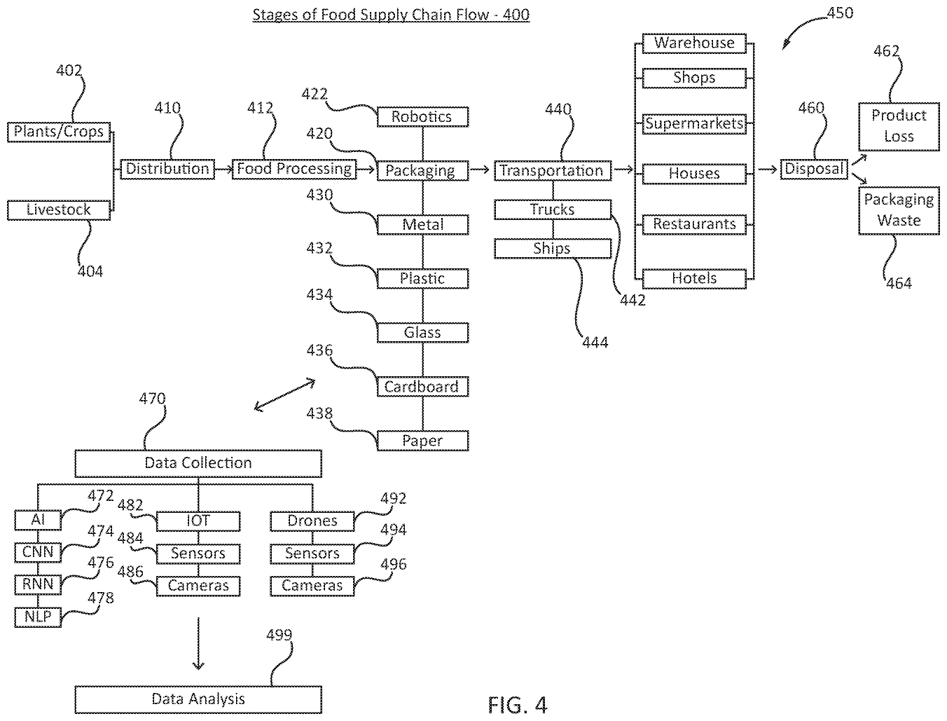

FIG. 4 is a block/flow diagram of a practical application illustrating stages of a food supply chain flow, in accordance with an embodiment of the present disclosure.

The stages of a food supply chain flow 400 are as follows.

In a first stage, plants and crops 402, as well as livestock 404 are utilized. The next stage is a distribution stage 410, which, in turn, leads to a food processing stage 412. After the food processing stage 412, a packaging stage 420 is employed. The packaging stage 420 can include robotics 422. The packaging stage 420 can package the goods, via the robotics 422, with metal 430, with plastic 432, with glass 434, with cardboard 436, and/or with paper 438. After the packaging stage 420, the transportation stage 440 is employed. The transportation stage 440 can include trucks 442 and ships 444 (e.g., container ships). The goods are transported to various locations 450, such as warehouses, shops, supermarkets, houses, restaurants, and hotels. The various locations 450 can also implement a disposal stage 460, which includes a product loss component 462 and packaging waste component 464.

Data collection 470 can occur at every stage of the food supply chain flow 400.

The data collection 470 can include artificial intelligence (AI) 472, which can encompass convolutional neural networks (CNN) 474, recurrent neural networks (RNN) 476, and natural language processing (NLP) techniques 478. The data collection 470 can employ Internet of Things (IoT) 482 with the aid of sensors 484 and cameras 486. The data collection 470 can further employ unmanned aerial vehicles (UAVs) 492, such as drones, which have sensors 494 and cameras 496 attached of affixed or mounted thereto.

The data collection 470 can be provided for data analysis by a data analyzer 499. The data analyzer 499 can determine that certain data is missing or not available or insufficient and can fill in the gaps for such data by requesting a service satellite provider communicate with the plurality of satellites that can acquire or obtain such missing or insufficient data.

This is an exemplary process for application of the context-aware automation architecture 10. The context-aware automation architecture 10 can be applied to any type of business process contemplated by one skilled in the art.

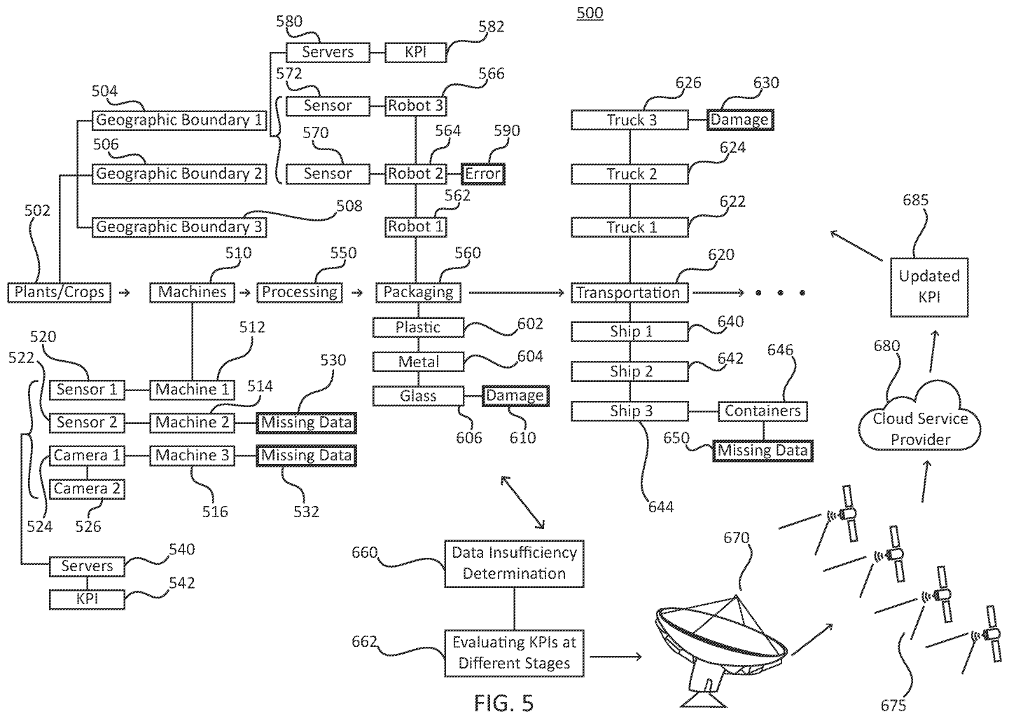

FIG. 5 is a block/flow diagram of a practical application illustrating the application of the context-aware automation architecture to a food supply chain flow, in accordance with an embodiment of the present disclosure.

In a practical application 500, in an agricultural environment, plants or crops 502 in a geographic boundary are processed. The plants or crops 502 can be divided into a first geographic boundary 504, a second geographic boundary 506, and a third geographic boundary 508. The plants or crops 502 are processed by machines 510. For example, the machines 510 can include a first machine 512, a second machine 514, and a third machine 516. The first machine 512 can be associated with a first sensor 520. The second machine 514 can be associated with a second sensor 522. The third machine 516 can be associated with a first camera 524 and a second camera 526. The system can detect that the second machine 514 has missing or insufficient data 530. The system can also detect that the third machine 516 has missing or insufficient data 532. The data or information collected from the first sensor 520, the second sensor 522, the first camera 524, and the second camera 526, including the missing data 530, 532 can be provided to a plurality of servers 540, which can analyze the data for the key performance indicators (KPIs) 542.

After the machines 510 collect the plants or crops 502, processing 550 takes place. After processing 550, the goods are received in a packaging stage 560. In the packaging stage 560, a plurality of robots can be used to package the goods. For example, a first robot 562, a second robot 564, and a third robot 566 can be employed. The second robot 564 can be associated with a sensor 570 and the third robot 566 can be associated with a sensor 572. An error 590 can be detected with regards to the second robot 564. The data or information collected from the sensor 570 and the sensor of 572, including the detected error 590, can be provided to a plurality of servers 580, which can analyze the data for the KPIs 582.

KPIs are key quantifiable indicators of progress toward an intended result. KPIs provide a focus for strategic and operational improvement, create an analytical basis for decision making and help focus attention on what matters most. Managing with the use of KPIs includes setting targets (the desired level of performance) and tracking progress against those targets. Managing with KPIs often means working to improve performance using leading indicators, which are precursors of future success, that will later drive desired impacts indicated with lagging measures.

KPIs provide teams with targets to aim for, milestones to gauge progress, and insights to help guide decision-making throughout an organization. By monitoring KPIs, organizations can identify areas of strength and weakness, make data-driven decisions, and take actions to optimize performance. The KPIs 542, 582 provide the team members of the agricultural practical application with insights into where missing data or errors occur, or where equipment damage may be located. As a result, the team members of the agricultural practical application can pinpoint the weaknesses in the agricultural business process and take remedial steps.

With further reference to the packaging stage 560, the packaging can also include using plastic 602, metal 604, and glass 606. The system can detect damage 610 when packaging involves the glass 606. Indication of the damage 610 can be flagged with the errors and the missing data in other parts of the agricultural business process.

After the packaging stage 560, transportation 620 takes place. The transportation 620 can include using a first truck 622, a second truck 624, and a third truck 626. The system may detect damage 630 to the third truck 626. The damage 630 can be, for example, the detection of a flat tire. As a result, the delivery of the goods may be delayed to one or more warehouses or supermarkets. Remedial steps can take place. The transportation 620 can also include using a first ship 640, a second ship 642, and a third ship 644. The third ship 644 can include a plurality of containers 646. A container ship is a cargo ship that carries all of its load in truck-size intermodal containers, in a technique called containerization. Regarding the containers 646, missing data 650 may be detected. The missing data 650 may involve one or more sensors or one or more cameras not operating properly (malfunctioning).

Subsequently, data insufficiency determination 660 takes place. Data insufficiency determination 660 can involve the detection of missing data, errors or damage within the agricultural business process flow 500. KPI evaluation 662 at different stages of the agricultural business process flow 500 can be performed in view of the data insufficiency determination 660. KPI data is then sent to a satellite service provider 670, which communicates with a plurality of satellites 675 which, in turn, communicate with a cloud service provider 680 to provide for updated KPI data 685. The updated KPI data 685 is then provided back to the agricultural business process flow 500 in order to fill in the gaps of the missing data or errors or damages that were detected previously. Therefore, the exemplary system identifies what data and information are missing or not considered by the ground hosted sources, and what additional data and information should be captured by the satellites to compensate for that. As a result, the exemplary system requests satellite service providers to communicate with a plurality of satellites to capture data or information that is missing or not available or insufficient and feed such new additional or supplemental or auxiliary data back into the agricultural business process flow 500 to fill in those data or information gaps.

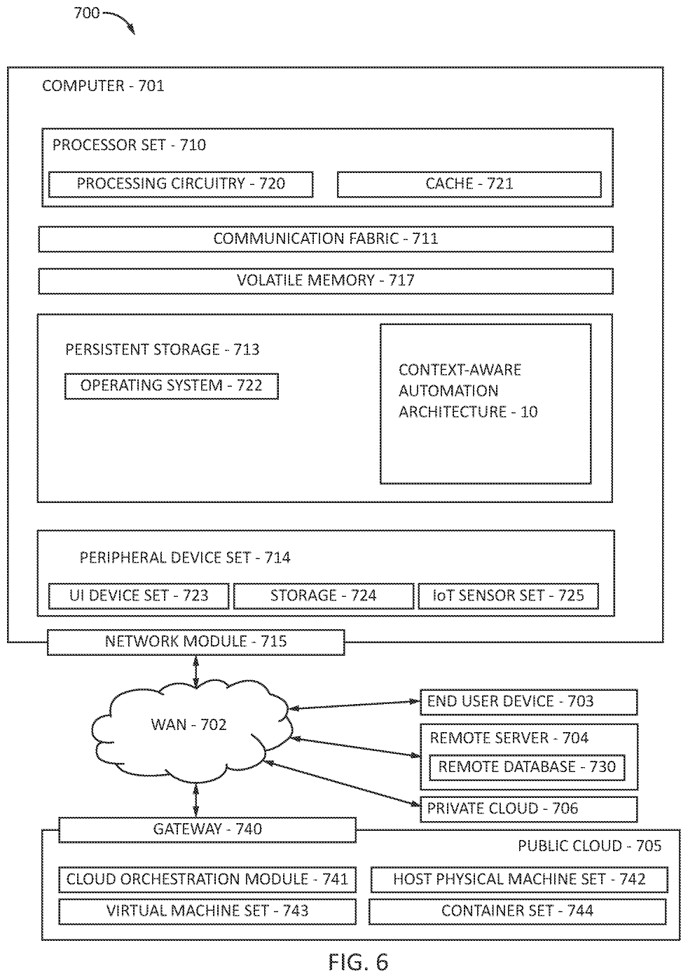

FIG. 6 is a block diagram of an exemplary computer system to apply the context-aware automation architecture of FIG. 1, in accordance with an embodiment of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the context-aware automation architecture 10. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

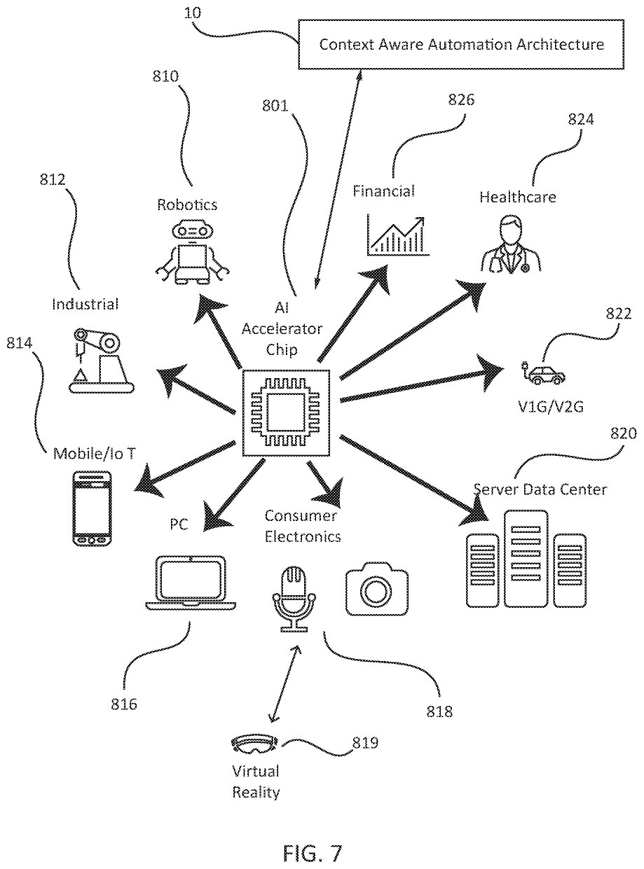

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

FIG. 7 illustrates practical applications for employing the context-aware automation architecture via an AI accelerator chip, in accordance with an embodiment of the present disclosure.

The artificial intelligence (AI) accelerator chip 801 can implement the context-aware automation architecture 10, and can be used in a wide variety of practical applications, including, but not limited to, robotics 810, industrial applications 812, mobile or Internet-of-Things (IoT) 814, personal computing 816, consumer electronics 818, including virtual reality (VR) applications 819, server data centers 820, vehicle-to-grid (V2G) applications 822, healthcare applications 824, and financial applications 826.

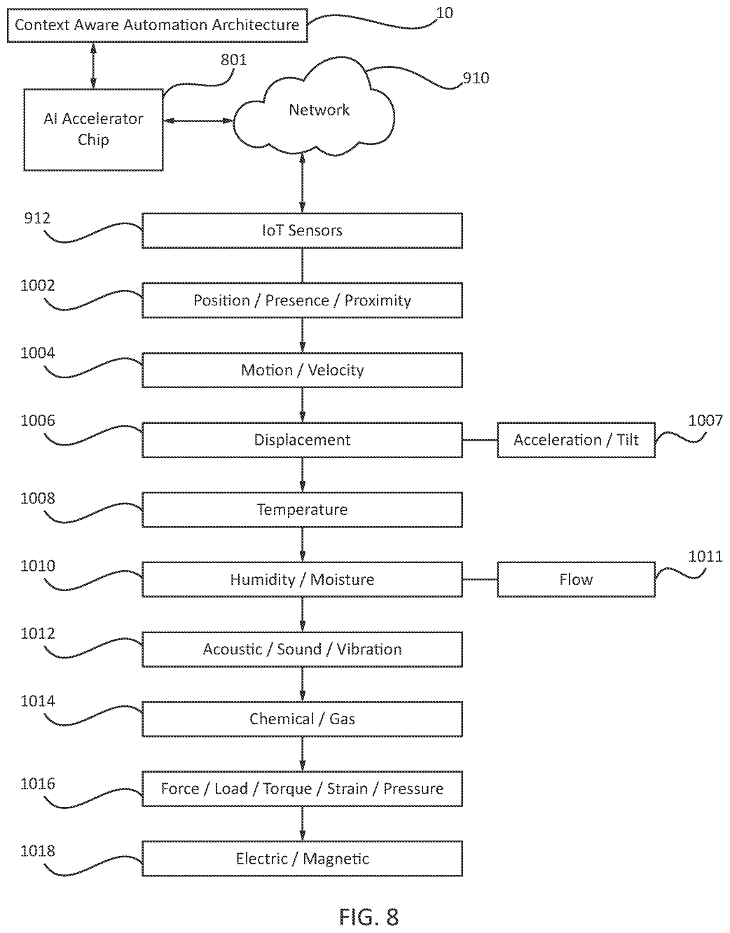

FIG. 8 is a block/flow diagram of exemplary IoT sensors used to collect data/information related to the context-aware automation architecture operations, in accordance with an embodiment of the present disclosure.

IoT loses its distinction without sensors. IoT sensors act as defining instruments which transform IoT from a standard passive network of devices into an active system capable of real-world integration.

The IoT sensors 912 can employ the AI accelerator chip 801 implementing the context-aware automation architecture 10 to transmit information or data, continuously and in in real-time, via a network 910, to any type of distributed system. Exemplary IoT sensors 912 can include, but are not limited to, position/presence/proximity sensors 1002, motion/velocity sensors 1004, displacement sensors 1006, such as acceleration/tilt sensors 1007, temperature sensors 1008, humidity/moisture sensors 1010, as well as flow sensors 1011, acoustic/sound/vibration sensors 1012, chemical/gas sensors 1014, force/load/torque/strain/pressure sensors 1016, and/or electric/magnetic sensors 1018. One skilled in the art can contemplate using any combination of such sensors to collect data/information of the distributed system for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

In conclusion, regarding FIGS. 1-8, based on an exemplary business process to be monitored at different stages of a lifecycle, based on inputs and outputs at different stages of the business process, based on various process quality matrices, based on geographic boundary coverage, based on duration of execution of different steps of the business process, etc., the exemplary methods use ground hosted sources of data (IoT, images, videos, etc.) to evaluate if there is any deviation at different stages of the business process, such as level of precision in monitoring and timely corrective action of the appropriate stage, and the exemplary methods use ground hosted sources of data (IoT, images, videos, etc.) to evaluate if information insufficiency is detected in monitoring and tracking different business processes. The exemplary system identifies what data and information are missing or not considered or rendered insufficient by the ground hosted sources, and what additional data and information are to be captured by satellites to compensate for that, and accordingly request satellite service providers to capture such supplemental or compensatory or auxiliary data and information.

The exemplary system analyzes the changes in contextual scenarios of the business process, that include, changes in the input or output, sequence of operations, weather conditions, demand, coverage boundary of the business process, deployment in new machines, robotic systems, damage to one or more sensors or cameras or equipment, etc. The exemplary system evaluates what data and information insufficiency occurs for the change in the context, and accordingly dynamically transmits software defined satellite rules to the satellite service providers to capture the supplemental or compensatory or auxiliary data or information.

Based on the available data and information from the ground hosted system, the level of quality of different KPIs at different stages of the business process are evaluated, and what additional data and information are needed for ensuring quality of KPI measurement is determined, and accordingly the exemplary system creates or generates software defined satellite requests based on data insufficiency determinations.

Moreover, if the business process is modified, e.g., updated with new machines, the exemplary system performs digital twin simulation of the machines being used for performing different stages of the business process workflow, and the exemplary system identifies what types of data and information are to be captured by the satellites so that the machines can perform the activity properly, and appropriate monitoring of the machines can be performed.

Therefore, based on dynamic detection of types of data and information insufficiency at different stages of the business process (e.g., damaged sensors are installed, a new machine is installed which requires new types of data to be captured, etc.), changes in the geographic boundary for execution of different business processes, the exemplary system dynamically requests appropriate missing data and information to be captured by the software defined satellites.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present disclosure, as well as other variations thereof, means that a particular feature, structure, characteristic, and so forth described in connection with the embodiment is included in at least one embodiment of the present disclosure. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for applying a context-aware automation architecture to a business process (which are intended to be illustrative and not limiting), it is noted that modifications and variations can be made by persons skilled in the art in light of the above teachings. It is therefore to be understood that changes may be made in the particular embodiments disclosed which are within the scope of the disclosure as outlined by the appended claims. Having thus described aspects of the disclosure, with the details and particularity required by the patent laws, what is claimed and desired protected by Letters Patent is set forth in the appended claims.

1. A method for implementing a context-aware automation system, the method comprising:
performing a business process within a geographical boundary;
capturing data from a plurality of sensors and cameras positioned in and around the geographical boundary, the data pertaining to different stages of the business process;
detecting contextual changes within the geographical boundary;
identifying data insufficiency within the different stages of the business process;
requesting a satellite service provider to initiate communication with one or more satellites to obtain complementary business process data based on software-defined satellite rules;
transmitting, by the one or more satellites, the complementary business process data based on the software-defined satellite rules to a cloud service provider communicating with one or more user terminals to evaluate a quality of key performance indicators (KPIs) extracted from the complementary business process data; and
employing one or more of the KPIs to resolve the data insufficiency within the different stages of the business process.

2. The method of claim 1, wherein the contextual changes include at least input changes, output changes, sequence of operation changes, weather condition changes, new machine deployment changes, robotic system changes, sensor malfunctions, camera malfunctions, and geographic boundary alterations.

3. The method of claim 1, wherein convolutional neural networks (CNNs) and natural language processing (NLP) techniques are applied to the captured data.

4. The method of claim 1, wherein a workflow of the business process is continuously monitored to determine potential changes or updates to the workflow to render adjustments to the software-defined satellite rules.

5. The method of claim 1, wherein the one or more satellites are selected based on their proximity to the geographical boundary.

6. The method of claim 1, wherein the captured data from the plurality of sensors and cameras is processed by one or more servers, the one or more servers configured to evaluate the different stages of the business process.

7. The method of claim 6, wherein the captured data from the plurality of sensors and cameras aids in determining which KPIs from the different stages of the business process to monitor.

8. The method of claim 1, wherein the data insufficiency identification is based on contextual changes within the geographical boundary.

9. A computer program product for implementing a context-aware automation system, the computer program product comprising a computer readable storage medium having program instructions embodied therewith, the program instructions executable by a computer to cause the computer to:
perform a business process within a geographical boundary;
capture data from a plurality of sensors and cameras positioned in and around the geographical boundary, the data pertaining to different stages of the business process;
detect contextual changes within the geographical boundary;
identify data insufficiency within the different stages of the business process;
request a satellite service provider to initiate communication with one or more satellites to obtain complementary business process data based on software-defined satellite rules;
transmit, by the one or more satellites, the complementary business process data based on the software-defined satellite rules to a cloud service provider communicating with one or more user terminals to evaluate a quality of key performance indicators (KPIs) extracted from the complementary business process data; and
employ one or more of the KPIs to resolve the data insufficiency within the different stages of the business process.

10. The computer program product of claim 9, wherein the contextual changes include at least input changes, output changes, sequence of operation changes, weather condition changes, new machine deployment changes, robotic system changes, sensor malfunctions, camera malfunctions, and geographic boundary alterations.

11. The computer program product of claim 9, wherein convolutional neural networks (CNNs) and natural language processing (NLP) techniques are applied to the captured data.

12. The computer program product of claim 9, wherein a workflow of the business process is continuously monitored to determine potential changes or updates to the workflow to render adjustments to the software-defined satellite rules.

13. The computer program product of claim 9, wherein the one or more satellites are selected based on their proximity to the geographical boundary.

14. The computer program product of claim 9, wherein the captured data from the plurality of sensors and cameras is processed by one or more servers, the one or more servers configured to evaluate the different stages of the business process.

15. The computer program product of claim 14, wherein the captured data from the plurality of sensors and cameras aids in determining which KPIs from the different stages of the business process to monitor.

16. The computer program product of claim 9, wherein the data insufficiency identification is based on contextual changes within the geographical boundary.

17. A system for implementing a context-aware automation system, the system comprising:
a memory; and
one or more processors in communication with the memory configured to:
perform a business process within a geographical boundary;
capture data from a plurality of sensors and cameras positioned in and around the geographical boundary, the data pertaining to different stages of the business process;
detect contextual changes within the geographical boundary;
identify data insufficiency within the different stages of the business process;
request a satellite service provider to initiate communication with one or more satellites to obtain complementary business process data based on software-defined satellite rules;
transmit, by the one or more satellites, the complementary business process data based on the software-defined satellite rules to a cloud service provider communicating with one or more user terminals to evaluate a quality of key performance indicators (KPIs) extracted from the complementary business process data; and
employ one or more of the KPIs to resolve the data insufficiency within the different stages of the business process.

18. The system of claim 17, wherein the contextual changes include at least input changes, output changes, sequence of operation changes, weather condition changes, new machine deployment changes, robotic system changes, sensor malfunctions, camera malfunctions, and geographic boundary alterations.

19. The system of claim 17, wherein convolutional neural networks (CNNs) and natural language processing (NLP) techniques are applied to the captured data.

20. The system of claim 17, wherein a workflow of the business process is continuously monitored to determine potential changes or updates to the workflow to render adjustments to the software-defined satellite rules.
